(19) United States
(12) Patent Application Publication
(10) Pub. No.: US 2007/0190500 A1
(43) Pub. Date: Aug. 16, 2007

(54) Method for expressing characters for reading by tactile sense and apparatus

(75) Inventors: Yoko Uemitsu, Kochi-shi (JP); Ikuko Shiotsubo, Kochi-shi (JP)

Correspondence Address: FITCH, EVEN, TABIN & FLANNERY, P. O. BOX 18415, WASHINGTON, DC, 20036, US

(73) Assignee: Kochi University, Kochi-shi, Kochi (JP)

(21) Appl. No.: 11/659,820

(22) PCT Filed: Jan. 20, 2005
(86) PCT No.: PCT/JP05/01031

§ 371 Date: Feb. 9, 2007

(30) Foreign Application Priority Data
Aug. 10, 2004 (JP) 2004-233530

(51) Int. Cl. G09B 21/00

(52) U.S. Cl. 434/113

(57) ABSTRACT

Provided is a method for expressing characters, which can reduce the pain at fingertip during tactile reading, allows easier recognition than conventional Braille characters, and be substituted for the Braille characters. Another object of the present invention is to provide a print and others having the characters formed, and an apparatus for mutual conversion between the characters and regular letters or between the characters and Braille characters. The method for expressing characters for reading by tactile sense according to the present invention comprises: deciding location of multiple lines; making one or more of the lines have a raised cross section; and expressing characters by a positional pattern of the raised cross section lines. The characters have a greater contact surface with the fingertip than conventional Braille characters, and thus, reduce the fatigue and the pain at fingertip drastically during tactile reading even for an extended period of time and also reduce misreading rate to a low level.

### TECHNICAL FIELD

The present invention relates to characters for reading by tactile sense, a print or the like having the characters formed thereon, and an apparatus for mutual conversion between the characters and regular letters or between the characters and Braille characters.

### BACKGROUND ART

Braille characters are characters for blind persons and a tactile code to be read by the fingertips. Each of the Braille characters consists of any one or more dots raised at six predetermined sites and is identified by the positional pattern of these raised dots, and the Braille characters are expressed with a maximum of 63 (2⁶−1) symbols. The original characters were invented by a Frenchman, Louis Braille. Japanese Braille characters expressing fifty Japanese syllabary were determined on the basis of the Braille formula in Japan in 1890 and have been used as the characters for blind persons since then.

Thus, the Braille's system has a long history, but also has some shortcomings. One of them is that it is very difficult to read. It has been pointed out that it is necessary to train a person from the early stages of development to bring him or her to a practical level allowing reading correctly and quickly.

In connection with the difficulty in reading, the Braille characters also have a problem in that it is difficult to recognize the range of each character, resulting in more frequent reading error. To add a mark to each character might be suggested to solve the problem, it is thought. However, the addition of such a mark to a Braille character consisting of dots makes it more difficult to identify the Braille character.

An advantage of the Braille characters is that it is possible to reduce the size of the characters and, as a result, to put a greater amount of information on a single page. However on the other hand, the reduction in the size of characters also causes further difficulty in reading, and once the finger misses the location of a letter among others, it is impossible to determine again its correct position. On the other hand, an attempt to solve the problem by enlarging the size of letter and the distance between letters eliminates the advantage of a great amount of information. Further, with the Braille characters, enlargement of letter size does not necessarily improve readability because it might disintegrate the unity of letter and the area covered by each letter becomes further unclear.

In addition, the Braille characters have a smaller contact surface with the fingertips, and thus are difficult to read if they are not tapered to some extent. This sharp surface causes fatigue and pain of the fingertips during tactile reading for a prolonged period of time, and thus makes it impossible, in some cases, to continue training for learning Braille at the stages not even mastered.

These problems associated with Braille characters are recently gathering more intense attention. This is due to the increase in the number of newly blinded persons caused by the aging associated with recent lengthening of life span and illnesses like diabetes. Braille characters are a very intricate tactile stimulus to be recognized. Especially for newly blind persons, whose sense of touch has been damaged by aging or by the peripheral nerve sensation deteriorated by diabetes, they are more difficult to learn. This is because detection of the raised dot of Braille becomes more difficult for those people. In addition, the pain and fatigue of the fingertips makes continuation of the practice even more difficult. For example, in institutions for the blind, the goal of training, for newly blind middle-aged adult and elderly persons is to acquire skill to “read the Braille characters on a single page (about 300 characters) within 5 to 10 minutes” by the end of a training period of six months to one year. This shows that an extended period of time is needed to bring newly blind persons to the level of practical tactile reading. A survey showed that only about 10 to 20% of totally blind persons could use the Braille characters at will and only about 10% or less of newly blind persons more than forty years old could use the Braille characters. It has been pointed out that not only training but also age at which training starts is critical to bring them to the reading speed equal to that of sighted persons.

For that reason, there are many methods investigated for substituting for the Braille characters. For example, vocal information exchange is one of such methods. However, the vocal exchange cannot allow exchange of a great amount of information. In addition to the problem in quantity, character is overwhelmingly better than voice, especially from the point of information management.

Alternatively, a method for raising regular letters as they are and making them read tactilely was also proposed in the invention described in JP-A No. 9-101740. Of course, the method does not demand learning of new characters. The method also specifies the color of characters and background for visually impaired persons. However, it is difficult for totally blind persons to read complicated characters only by tactile sense. It is extremely difficult to read even a relatively simpler katakana (a kind of Japanese character), which consists of multiple lines of various lengths and angles, only by tactile sense, and thus, the method is still not practical.

On the other hand, research for making the Braille characters more readable and recognizable by modifying the layout and size of the Braille characters was also undertaken. For example, the fact that certain elongation of the distance between dots was effective in increasing tactile reading speed and improving tactile identification by diabetic patients was disclosed in Atsushi Nakano and four researchers, “Tactual Discrimination in Adventitiously Blind Adults with Diabetic Retinopathy (2)—Development of Size Changeable Braille Embossing System—”, Internet site: <URL: http://www.econ.keio.ac.jp/staff/nakanoy/article/braille/BR/chap3/3-5/3-5.html> and Seiji Maeda, “Research on the support for newly blind persons in learning Braille characters”, Internet site: <URL: http://sun-cc.juen.ac.jp:8080/ era/v1PDF/Maeda.PDF>. Further, in Takaaki Masai and two researchers “Research on the guidance on Braille characters for newly blind persons”, Japan Tokushu Kyoiku Gakkai Ronbunshu (Bulletin of the Soc. Japan. Special Education), p. 335 (2003), it is described that “large size Braille characters”, which are larger in the size of dots and the distance between dots, were more effective in increasing the easiness of reading by newly blind persons than conventional standard-sized Braille characters.

However, there is a need for a new tool other than the Braille characters, to fundamentally overcome the problems inherent to the Braille characters such as relatively higher frequency of misreading, difficulty in tactile reading, unsuitability to long-term tactile reading due to the pain at fingertips, and difficulty in learning. In addition, there is almost no development for characters other than the Braille characters or no patent application filed for protection of the study results by companies. This is probably because the Braille characters have been used for a long period and is already authorized. Further, if new characters are developed, there is a possibility that they may not be patented because they are regarded as mere arbitrary arrangements using no natural law and they do not have technical advantages.

### SUMMARY OF THE INVENTION

As in the circumstances described above, Braille characters have been used as the characters for blind persons. However there is a problem that the characters were still difficult for the newly blind persons increasing in number recently to recognize only by tactile sense and to learn, for example, because the pain in the fingertips makes continuation of practice difficult. For that reason, there is an urgent need for a new set of characters for tactile reading substituting for the Braille characters for blind persons.

Thus, the purpose of the present invention is to provide a method for expressing characters which can reduce the pain at fingertip during tactile reading, allows easier recognition than conventional Braille characters, and can be substituted for the Braille characters. Another object of the present invention is to provide a print and others having the characters formed thereon, and an apparatus for mutual conversion between the characters and regular letters or between the characters and Braille characters.

To meet the urgent demand and needs of newly blind persons who wanted characters, the inventors have studied various characters which might possibly substitute for the Braille characters. As a result, the inventors have found that characters consisting of raised-cross section lines have some technical advantages in reducing the pain at fingertip because they have a larger contact surface than the Braille characters consisting of dots and making it easier to read than the Braille characters, and completed the present invention.

Accordingly, a method for expressing characters for reading by tactile sense according to the present invention, comprises: deciding location of multiple lines; making one or more of the lines have a raised cross section; and expressing characters by a positional pattern of the raised cross section lines. Hereinafter, the characters may be expressed by the method will be referred to as “line characters”.

In the method above, an additional raised mark is preferably placed in each character. The raised mark allows easier recognition of the range of a character, and thus, makes it easer to read. In addition, such a configuration makes the characters according to the present invention distinctly different from the conventional Braille characters, in which such a mark could not be formed because it was difficult to differentiate the mark from the constituent dots.

In the method above, the number of the raised-cross section lines is preferably 0 to 3 vertically and 0 to 3 horizontally. The number of characters expressed by the line patterns is sufficient, if the number of lines is in the range above. On the other hand, a greater number of raised-cross section lines make it difficult to read the characters only by tactile reading. The number of positions on which the lines are placed is preferably 4 to 8 and particularly preferably 6. When the number of positions is 4, the maximum number of the positional patterns of raised-cross section lines is 2⁴=16. Although the number of characters expressed by the line patterns may seem too low, it is sufficient for expressing numbers, and the number of the characters expressed increases drastically, for example, if a character is expressed with two line characters in combination. On the other hand, when the number of positions is more than 8, it becomes difficult to read the characters only by tactile reading. The number of positions at 6, at which the Braille characters consisting of 1 to 6 dots can be converted to 1 to 6 raised-cross section lines orderly, is very convenient.

A print, planer plate and container according to the present invention are characterized in that the characters expressed by the method above are formed thereon. The print has a potential as a substitute for the conventional Braille character print. The planer plate is a resin or metal plate or the like having the line characters formed, and may be used, for example, as a guide plate and also as a planographic plate for making the print according to the present invention. The container is useful in informing blind persons of its content.

A regular letter-processing device according to the present invention comprises an input device for inputting a regular letter data; a processing device to convert the regular letter data inputted to the input device into a data of line character expressed in a line positional pattern; and an output device to output the line character data processed in the processing device; wherein the processing device includes a memory unit storing multiple pieces of a line character data respectively corresponding to a regular letter data; and a retrieving unit to retrieve the line character data corresponding to the inputted regular letter data from the memory unit.

A first line character-processing device according to the present invention comprises an input device for inputting a data of line character expressed in a line positional pattern; a processing device to convert the line character data inputted to the input device into a regular letter data; and an output device to output the regular letter data processed in the processing device; wherein the processing device includes a memory unit storing multiple pieces of a line character data respectively corresponding to a regular letter data; and a retrieving unit to retrieve the regular letter data corresponding to the inputted line character data from the memory unit.

A Braille character-processing device according to the present invention comprises an input device for inputting a Braille character data; a Braille character/line character converting device to convert the Braille characters data inputted to the input device into a data of line character expressed in a line positional pattern; and an output device to output the line character data converted by the Braille character/line character converting device; wherein the Braille character/line character converting device includes a memory unit storing multiple pieces of a line character data respectively corresponding to a Braille characters data; and a retrieving unit to retrieve the line character data corresponding to the inputted Braille characters data from the memory unit.

A second line character-processing device according to the present invention comprises an input device for inputting a data of line character expressed in a line positional pattern; a line character/Braille character converting device to convert the line character data inputted to the input device into a Braille characters data; and an output device to output the Braille characters data converted in the line character/Braille character converting device; wherein the line character/Braille character converting device includes: a memory unit storing multiple pieces of a line character data respectively corresponding to a Braille characters data; and a retrieving unit to retrieve the Braille characters data corresponding to the inputted line character data from the memory unit.

These apparatuses make the communication possible between a blind person and a sighted person or between blind persons, by conversion between line characters and regular letters or between line characters and Braille characters.

In the regular letter-processing device or Braille character-processing device, the output device preferably has an apparatus to form the line characters corresponding to processed line character data three-dimensionally on a capsule paper, paper, planer plate or container. These apparatuses are typical examples of apparatuses for forming line characters three-dimensionally.

### BRIEF DESCRIPTION OF THE DRAWINGS

FIG. 1 is a view showing an example of the positional configuration of the line character according to the invention when the number of line locations is 4. A raised mark is placed at the center of the character.

FIG. 2 is a view showing another example of the positional configuration of the line character according to the invention when the number of line locations is 8. A raised mark is placed at the center of the character.

FIG. 3 is a view showing an example of the rule converting the conventional Braille characters into the characters according to the present invention.

FIG. 4 is a system block diagram illustrating the apparatus according to the present invention.

In FIG. 4, 1 represents an input device; 2, a processing device; 3, a retrieving unit; 4, a memory unit; and 5, an output device.

### BEST MODE OF CARRYING OUT THE INVENTION

The method for expressing characters for reading by tactile sense according to the present invention is characterized by deciding location of multiple lines, making one or more of the lines have a raised cross section, and expressing characters with a positional pattern of the raised-cross section lines. The line having a raised cross section has a contact surface to fingertip greater than a raised dot, and thus, can reduce the pain at fingertip drastically even during tactile reading or practice for an extended period of time. In addition, according to the findings by the inventors, the characters expressed by raised-cross section lines lead to a significantly smaller misreading rate than Braille characters and are easier for tactile reading. It is probably because presence or absence of raised-cross section lines can be recognized more easily than that of raised dots. Thus, the characters according to the present invention consisting of raised-cross section lines are particularly useful for newly blind persons who have deteriorated fingertip sense due to aging or disease.

In the method according to the present invention, the locations of the multiple lines are decided first. That is, persons who read the characters according to the present invention tactilely judge the presence or absence of raised-cross section lines at predetermined positions, and thus can identify the characters relatively easily. The characters according to the invention are distinctively different from wedge-shaped characters and raised katakana characters in this point. More specifically, these conventional characters, each of which is expressed in a unique shape of its own, are not expressed by the positional pattern of lines at predetermined positions, and thus, should be identified with the lines or curves constituting each character in various lengths and angles and read with the overall figure expressed by them. As a result, identification thereof only by tactile sense is very difficult. On the other hand, the characters according to the invention demand only recognition of the lines present or absent at predetermined positions by tactile sense, and does not demand differentiation of the length and others of lines and the entire shape.

In the method according to the present invention, one or more lines at predetermined positions are raised-cross section lines. The cross-sectional shape is not particularly limited, if the lines can be recognized as raised when it is felt with the fingertip. For example, the shape may be rectangular, almost rectangular, or arch-shaped. However, if the cross section is rectangular, the corners are preferably rounded for alleviating the pain at the fingertip. Although the height of the cross section is also not particularly limited, it may be, for example, approximately 50 μm to 1 mm.

The characters according to the present invention are expressed by the positional pattern of the raised-cross section lines at predetermined positions. Accordingly, it is needed to decide which positional pattern corresponds to which character in advance. In that sense, the characters are based on arbitrary arrangements. However, the characters according to the present invention, which are formed with raised-cross section lines, give at least technical advantages of reducing the pain at fingertip or the like and allowing easier identification, and thus, the method according to the present invention may be regarded as an invention complying with the definition in the Japanese Patent Law.

The character according to the present invention, which is aimed for use in tactile reading, is in the size suitable for access with the fingertip. Specifically, the optimal size of the characters is decided properly after studying the relationship thereof with tactile reading speed and misreading rate. The standard size of a conventional Braille character is 6 mm in height and 4 mm in width. Considering the raised-cross section lines constituting the character and the need for the size allowing tactile fingertip reading, the size of the character according to the present invention may be, for example, approximately 5 to 20 mm in height and 3 to 12 mm in width. In addition, the optimal width of the raised line may be, for example, about 1 mm, considering the dot diameter of conventional standard Braille characters of 1.2 to 1.4 mm and the easiness in tactile reading, although this still depends on future research. However, the relationship between the size and others of the characters and tactile reading speed or reading error rate is not clearly understood yet, and the optimal size and width remain to be optimized in the future and are not limited to the range above.

In the method according to the present invention, an additional raised mark is preferably placed in each character. Accurate identification of the range of a character reduces reading error rate drastically in tactile reading. However, it was not possible to place such a mark in conventional Braille characters. It is because addition of a raised dot as the mark in each Braille character, which consists of raised dots and has a smaller contact area with the fingertip, makes it difficult to differentiate the mark dot from other raised dots constituting the character, consequently leading to decrease in tactile reading speed and increase in error rate. Alternatively, for example, addition of an underline in each character, which is more stimulatory than the Braille character, makes it difficult to identify the Braille character, also leading to increase in the error rate. On the other hand, the characters according to the present invention consisting of raised-cross section lines, which have a greater contact surface with fingertip, do not reduce the identification efficiency of characters even if such a mark is formed. If such a raised mark is formed, it becomes possible to recognize a character having no raised line (lines on all predetermined positions are not raised-cross section lines) as a character.

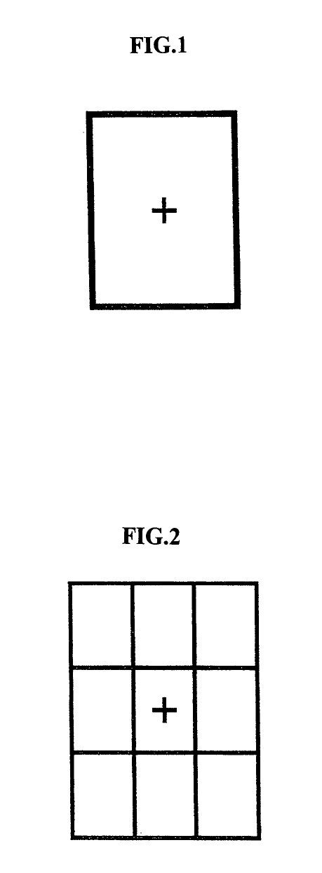

The kind and the position of the raised mark may be decided properly according to each character according to the present invention. For example, when the characters according to the present invention are expressed by 1 to 6 raised-cross section lines and respective vertical and horizontal line locations are arranged in the configuration of “ [symbol] ” as will be described below, a raised dot, a small raised cross, or the like may be placed at the center of the character. In such a case, it is not possible to place the mark or difficult to recognize the mark, even if formed, when there are both raised vertical and horizontal lines inside or the character (vertical and horizontal lines inside the external frame, lines 2 and 5 in FIG. 1), but the intersection of the raised vertical and horizontal lines can function as the mark in each character. It is because no such a raised cross is formed in other regions.

In the method according to the present invention, presence of the raised mark prevents decrease in tactile reading speed and reduces the misreading rate during reading of a longer string of characters, in particular, because (i) it is possible to know the order of the characters according to the present invention in the line during reading, (ii) it is easier to locate the finger on the track of movement, and (iii) it is easier to know the position of the finger.

These effects are more distinct, in particular, when the number of characters to be read is longer or a sentence is read. With the conventional Braille characters consisting of dots having a smaller contact surface with the fingertip, it is difficult to differentiate the area having dots from the area having no dots and to know the range occupied by a character. As a result, when multiple Braille characters are arranged in succession, it becomes difficult to distinguish whether a particular dot forms a character with the left or the right dot row, leading to decrease in tactile reading speed and increase in misreading rate. On the other hand, the characters according to the present invention, which consist of raised-cross section lines having a greater contact surface with the fingertip, allow recognition of each line and also the region having no raised-cross section line. As a result, it is easier to know the range occupied by a character, resulting in increase in tactile reading speed and in particular drastic decrease in the frequency of misreading.

In the characters according to the present invention, the number of the positions on which the lines are placed is not particularly limited. However, because the characters according to the present invention are recognized by tactile sense, an excessively greater number of lines is undesirable from the point of identification efficiency. On the other hand, a smaller number of lines results in decrease of the number of characters that can be expressed. From the point above, the number of positions on which the lines are placed is preferably 4 to 8, most preferably 6.

When the number of line location is 4, for example, the lines are arranged in the shape of “□” as shown in FIG. 1. In such an embodiment, combination of four lines can express up to 2⁴=16 characters. Such a combination is not sufficient for expressing all kana (Japanese characters) or alphabet characters, but is sufficient for expressing numbers. Alternatively, when the number of line location is 8, the lines are arranged, for example, in the shape shown in FIG. 2. In such an embodiment, combination of eight lines can express up to 2⁸=256 characters.

When the number of line location is 6, combination of lines can express up to 2⁶=64 characters. In addition, because the Braille characters are expressed with six dots, the Braille characters can be converted into the characters according to the present invention under a certain rule.

In the embodiment where the number of line location is six, 0 to 3 raised-cross section lines may be arranged vertically and 0 to 3 lines horizontally. For example, the location of 6 raised lines may be arranged in the shape of “ [symbol] ”, and characters be expressed respectively with presence or absence of respective vertical and horizontal lines. In such a case, vertical and horizontal raised section lines crossing orthogonally or almost orthogonally to each other are more advantageous for recognition by tactile sense than those arranged as inclined to each other.

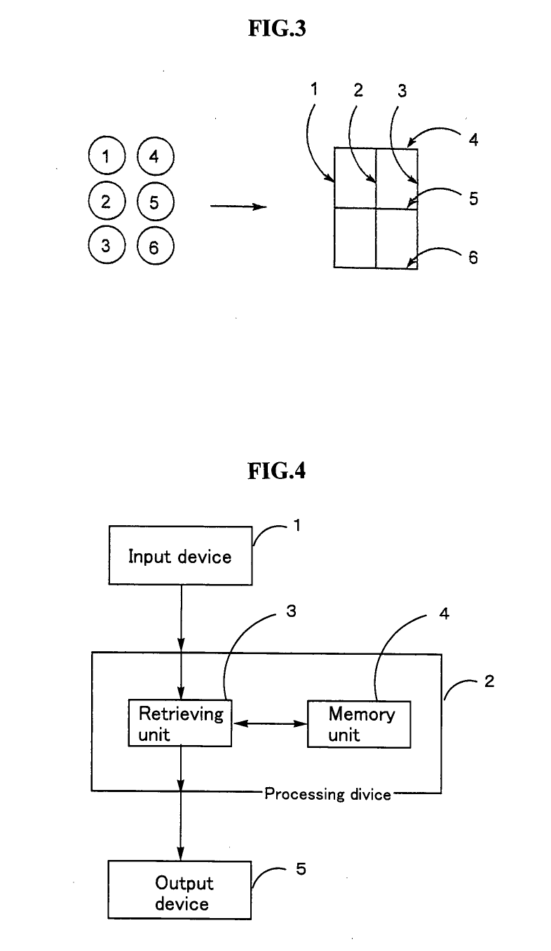

In the expression embodiment, the conventional Braille characters can be converted into the inventive characters individually. That is, because the Braille characters are expressed by presence or absence of the six dots arranged on two rows of three vertical locations, the Braille characters can be converted to the characters according to the present invention, for example, according to the rule shown in FIG. 3. More specifically, they may be converted as shown in Tables 1 to 3. In the Tables, the characters according to the present invention are indicated by “line character”, and a raised mark is placed at the center of each character. In the Braille characters, a black spot represents a raised dot. There are some Braille and line characters that are the same as each other between alphabet and kana. For example, a kana character “ [symbol] ” and an alphabet character “a” are represented by the same Braille and line character. In Japanese Braille characters, an alphabet is differentiated by putting the “foreign character mark” shown in Table 2 in front, and the alphabet characters are differentiated similarly in the present invention.

TABLE 1

| | Japanese | |
|---|---|---|
| | Braille | Line |
| Kana | character | character |
| [symbol] | 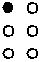 | 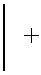 |
| [symbol] | 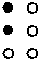 | 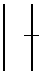 |
| [symbol] | 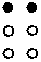 | 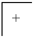 |
| [symbol] | 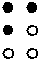 | 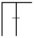 |
| [symbol] | 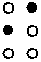 | 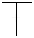 |
| [symbol] | 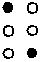 | 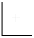 |
| [symbol] | 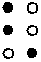 | 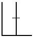 |
| < | 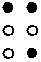 | 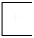 |
| [symbol] | 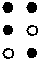 | 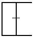 |
| [symbol] | 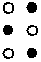 | 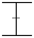 |
| [symbol] | 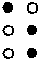 | 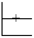 |
| [symbol] | 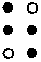 | 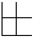 |
| [symbol] | 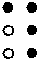 | 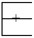 |
| [symbol] | 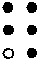 | 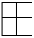 |
| [symbol] | 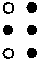 | 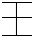 |
| [symbol] | 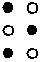 | 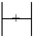 |
| [symbol] | 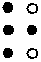 | 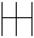 |
| [symbol] | 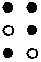 | 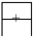 |
| [symbol] | 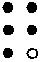 | 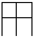 |
| [symbol] | 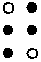 | 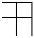 |
| [symbol] | 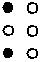 | 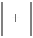 |
| [symbol] | 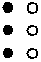 | 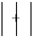 |
| [symbol] | 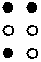 | 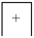 |
| [symbol] | 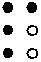 | 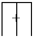 |
| [symbol] | 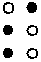 | 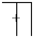 |
| [symbol] | 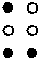 | 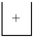 |
| [symbol] | 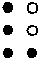 | 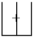 |
| [symbol] | 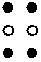 | 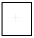 |
| [symbol] | 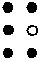 | 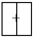 |
| [symbol] | 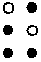 | 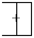 |
| [symbol] | 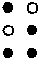 | 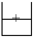 |
| [symbol] | 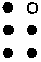 | 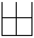 |
| [symbol] | 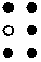 | 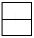 |
| [symbol] | 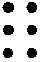 | 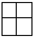 |
| [symbol] | 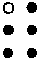 | 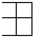 |
| [symbol] | 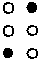 | 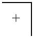 |
| [symbol] | 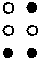 | 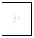 |
| [symbol] | 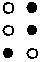 | 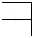 |
| [symbol] | 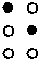 | 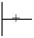 |
| [symbol] | 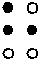 | 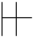 |
| [symbol] | 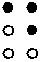 | 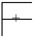 |
| [symbol] | 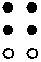 | 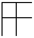 |
| [symbol] | 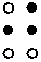 | 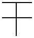 |
| [symbol] | 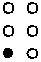 | 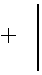 |
| [symbol] | 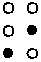 | 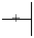 |
| [symbol] | 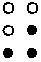 | 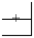 |

TABLE 2

| | Japanese | |
|---|---|---|
| | Braille | Line |
| Mark | character | character |
| Double consonant mark | 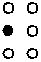 | 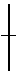 |
| Echo mark | 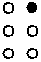 | 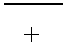 |
| Indication mark | 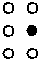 | 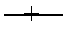 |
| Capital character mark | 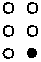 | 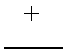 |
| Long vowel mark | 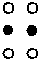 | 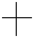 |
| Connection mark | 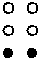 | 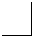 |
| Citation mark | 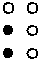 | 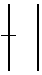 |
| Echoic- voiced sound mark | 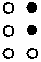 | 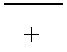 |
| Foreign character mark | 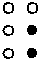 | 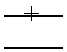 |
| Question mark | 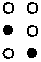 | 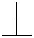 |
| Special sound mark | 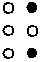 | 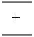 |
| Poetical line mark | 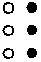 | 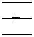 |
| Punctuation mark | 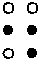 | 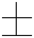 |
| Exclamation mark | 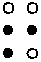 | 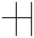 |
| Foreign- word citation mark | 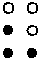 | 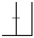 |
| Parenthesis | 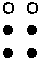 | 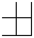 |
| Number mark | 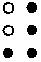 | 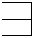 |

TABLE 3

| | Braille | Line |
|---|---|---|
| Alphabet | character | character |
| a | 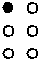 | 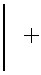 |
| b | 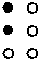 | 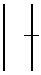 |
| c | 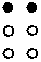 | 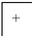 |
| d | 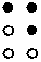 | 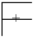 |
| e | 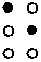 | 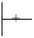 |
| f | 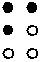 | 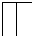 |
| g | 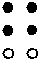 | 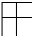 |
| h | 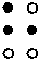 | 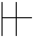 |
| i | 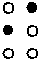 | 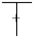 |
| j | 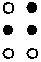 | 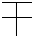 |
| k | 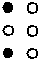 | 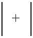 |
| l | 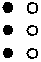 | 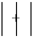 |
| m | 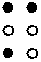 | 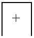 |
| n | 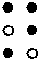 | 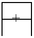 |
| o | 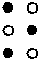 | 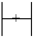 |
| p | 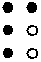 | 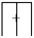 |
| q | 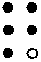 | 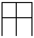 |
| r | 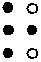 | 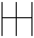 |
| s | 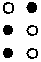 | 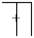 |
| t | 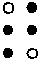 | 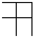 |
| u | 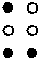 | 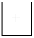 |
| v | 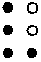 | 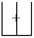 |
| w | 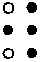 | 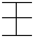 |
| x | 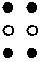 | 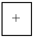 |
| y | 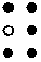 | 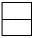 |
| z | 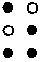 | 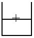 |

The method for forming the characters in the method according to the present invention and the medium on which the characters are formed are not particularly limited, and any one of conventional methods may be applied. For example, the characters may be formed on paper by using a so-called three-dimensional copying system. The system includes a set of a capsule paper, a three-dimensional copying machine and a three-dimensional developing machine. Specifically, the capsule paper is a paper coated with thermally expandable polystyrene microcapsules. It is possible to expand the microcapsules in the region desirably expanded by irradiation of a laser beam or the like. The characters according to the present invention can be formed by copying the characters according to the present invention on a capsule paper in a three-dimensional copying machine and expanding the printed region by heat treatment in a three-dimensional developing machine. Alternatively, the method for Braille typewriter used in forming Braille characters may also be applied.

The characters according to the present invention can also be formed by cutting or press-molding a planer plate such as of resin, metal, or wood. Such a resin plate can also be prepared by injecting a molten resin into a mold and hardening the resin therein. The planer plates are useful as a guide plate and the like. In particular, metal plates having the characters according to the present invention formed thereon can also be used, for example, as a planographic plate for forming the characters according to the present invention on paper.

The characters according to the present invention may also be formed on containers of commodities such as shampoo for improvement in the quality of life of blind persons. In such a case, the characters according to the present invention may be formed thereon by applying a conventional container-forming method such as an injection molding system.

The apparatus according to the present invention is an apparatus for mutual conversion between the characters according to the present invention (line characters) and regular letters or between the characters according to the present invention and Braille characters. Hereinafter, although a regular letter-processing device for converting regular letters into the characters according to the present invention will be described mainly, the line character-processing device for converting the characters according to the present invention into regular letters, the Braille character-processing device for converting Braille characters into the characters according to the present invention, or the line character-processing devices for converting the characters according to the present invention into Braille characters may also have a similar configuration.

The regular letter-processing device according to the present invention is characterized by comprising an input device for inputting a regular letter data, a processing device to convert the regular letter data inputted to the input device into a data of line character expressed in a line positional pattern, and an output device to output the line character data processed in the processing device, wherein the processing device includes a memory unit storing multiple pieces of a line character data respectively corresponding to a regular letter data, and a retrieving unit to retrieve the line character data corresponding to the inputted regular letter data from the memory unit. The “line characters, i.e., the characters expressed in line positional pattern”, are the characters according to the present invention described above. The system block diagram of the apparatus is shown in FIG. 4.

The “input device” 1 for inputting regular letter data is a device for inputting regular letters and instructing to process the characters, and examples thereof include keyboard, mouse, pen and the like that are used in general applications such as word processor for inputting regular letters. General applications such as Braille electronic organizer may be applied to the “input device” 1 in the Braille character-processing device, and applications allowing input of line characters such as Braille electronic organizer-modified apparatus may also be used as the “input device” 1 in the line character-processing device. The regular letter data inputted to the “input device” 1 are sent to the next “processing device” 2.

The “processing device” 2 has a “memory unit” 3 for storing multiple pieces of line character data respectively corresponding to the regular letter data, and a “retrieving unit” 4 to retrieve the line character data corresponding to the inputted regular letter data from the memory unit.

The “memory unit” 3 stores the regular letter data and the corresponding line character data. For example, it stores the line characters previously determined according to respective regular letters, as shown in Table 1. In the Braille character-processing device or line character-processing device for mutual conversion between Braille and line characters, it stores the line characters respectively corresponding to the Braille characters in advance.

The “retrieving unit” 4 in the “processing device” 2 retrieves the line character data corresponding to the regular letter data inputted to the “input device” 1 from the “memory unit” 3. The “retrieving unit” 4 in the Braille character-processing device or line character-processing device for mutual conversion between Braille and line characters retrieves the line or Braille character data respectively corresponding to the inputted Braille or line character data from the “memory unit” 3 similarly.

The “output device” 5 is a device for retrieving the line character data corresponding to the inputted regular letter data from the “processing device” 2 and outputting the data. Typical examples of the “output device” 5 include the three-dimensional copying machines described above, cutting or injection-molding apparatuses for forming line characters on a planer plate, dot-impact printers or modifications of conventional Braille printers, and the like. If the line characters respectively corresponding to regular letters are shown only as information for sighted persons, the line characters may be shown by using a conventional printer or display as the “output device”. In the Braille character-converting device for converting Braille characters into line characters, it is also possible to use a similar “output device” 5. In the line character-processing device for converting line characters into regular letters, these conventional printers and the like may be used as the “output device” 5.

The characters according to the present invention (line characters) are much easier to identify, consequently leading to improvement in tactile reading speed and giving a misreading rate smaller than that of conventional Braille characters. In addition, the characters also reduce fingertip pain significantly during tactile reading for an extended period of time, and thus, are easier to learn for the patients who are newly blinded, for example, by diabetes. Thus, the characters according to the present invention cannot only substitute for conventional Braille characters, but also provide an important communication tool for those who find difficulty in learning Braille characters. In addition, the apparatus according to the present invention enables communication by character between a sighted person or a Braille character user and a line character user, and can be used as a tool for learning line characters.

Hereinafter, although the present invention will be described more specifically with reference to Examples, it should be understood that the present invention is not restricted by the following Examples, modifications can be made within the scope of the description above and below, and such modifications are also included in the technical scope of the present invention.

### EXAMPLES

### Production Example 1

### Preparation of the Characters According to the Present Invention, i.e. Line Characters

All Braille characters in six-dot patterns, (2⁶−1=63 patterns, because the character with no dot was eliminated) were converted to line characters having three vertical and three horizontal lines according to the rule shown in FIG. 3. The converted line characters were drawn on a commercially available A4 copy paper in a character size of 15 mm in height and 10 mm in width with a 1-mm Rotring. The character size is within range of most recognizable sizes as Braille characters from the results shown by the preceding studies, which was larger by 2.5 times than that of Braille characters used in a commonly-used standard Braillewriter (manufactured by Nakamura Braillewriter) or a Braille printer (ESA721 manufactured by JTR) and approximately twice larger than that of the expanded Braille characters used in a 27-square Braillewriter (manufactured by Nakamura Braillewriter) or an L-size printer (manufactured by JTR). The width of the line was set to 1 mm, because the diameter of the dots in general Braille characters is 1.2 to 1.4 mm and the lines becomes raised by foaming in three-dimensional copying.

Then, each of the characters was printed on an A4-sized capsule paper (manufactured by Matsumoto Yushi-Seiyaku) one by one in a three-dimensional copying machine (EP2051, manufactured by Minolta), and was foamed in a three-dimensional developing machine (YMT-A3, manufactured by Matumoto Kosan) into a raised character.

In addition, a cruciform protuberance was formed at the center of each character (at the center of a rectangle of 15 mm in height and 10 mm in width). It is a reference for experimental participants to read the characters only made of one vertical line and one horizontal line and to move the finger more efficiently, by allowing the participants to recognize the center position. The protuberance at the center is coated with an instant adhesive (Aron Alph, manufactured by Toagosei) and dried, to make it more recognizable than the character formed by only three-dimensional copying. Further, marks indicating starting positions of both hands were formed at both bottom corners of the sheet.

### Example 1

By using the 63 line character samples prepared in Preparative Example 1 above, (i) the time for reading one character, (ii) the time for reading all 63 characters, and (iii) the error number were determined, and the average, the standard deviation and others were calculated. The total number of participants of the experiment was 16: 7 sighted college students who had no experience of reading Braille characters, 8 sighted adults who had no experience of reading Braille characters, and 1 student in blind school who was using Braille characters.

Specifically, eye-masked participants were first made to have an image on the line characters by explaining them the figures and allowing them to touch the figures and using ten kinds of line character samples of which the configuration and the shape are easier for the participants to recognize such as the character having all six lines. Then, the method for orally describing the line character samples was explained. For example, if presence of a horizontal line is recognized above the protuberance at the center or the intersection point of the second vertical and second horizontal lines, the participants were advised to say “first horizontal line”, and if presence of a vertical line is recognized to the right thereof, they are advised to say “third vertical line”. However, the participants were advised that it was essentially arbitrary to decide whether to use the protuberance at the center as a reference and how to use both hands.

After the general guidance, the participants were asked to practice. First, they are were asked to touch the marks on the bottom corners of the sheet with both hands, then to touch the line character at the center freely, and tell which line or lines composing the character were there. The correct answer was fed back for each response. Then another stimulus sheet of line character was presented and a new trial of practice started again. These practices were repeated ten times. All participants were asked whether they wanted additional practice after this series of practice. No participant needed more practice.

After the practice session, the actual test was performed. The line character to be read and hand movement of participants from when the participants were asked to place their both hands on the marks on the bottom corners of the sheet to when the participants moved their finger and answered the constitution of the line character were monitored with a video camera, and the data were recorded on DVD. The time from when the fingertip reached the line character until the participant replied the shape was determined from the data recorded, by using a behavior-coding system (IFS-18 Ver. 1.8.2, manufactured by DHK Co., Ltd.). The time is referred to as “one-character reading time”. The 63 sheets, which were too many, were divided to half into a total of two sets of ring-bound sheets, and each of them was given randomly to the participant.

The “behavior-coding system” used is a device recording and analyzing the movement of participant body and the time needed for the movement. Results are summarized in Table 4.

TABLE 4

| | Average of | | | |
|---|---|---|---|---|
| | one-character | | 63-character | |
| | reading | Standard | reading | Error |
| | time (sec) | deviation | time (sec) | number |
| Subject 1 | 17.82 | 4.67 | 1122.87 | 0 |
| Subject 2 | 14.15 | 3.42 | 891.63 | 6 |
| Subject 3 | 12.27 | 3.52 | 773.3 | 1 |
| Subject 4 | 16.27 | 6.50 | 1024.95 | 0 |
| Subject 5 | 11.91 | 5.27 | 750.13 | 2 |
| Subject 6 | 18.61 | 8.20 | 1172.63 | 2 |
| Subject 7 | 13.76 | 8.51 | 867.15 | 1 |
| Subject 8 | 10.25 | 3.43 | 645.75 | 0 |
| Subject 9 | 8.26 | 2.23 | 520.51 | 1 |
| Subject 10 | 17.55 | 9.71 | 1105.74 | 3 |
| Subject 11 | 7.89 | 3.01 | 497.19 | 0 |
| Subject 12 | 8.47 | 3.01 | 533.54 | 1 |
| Subject 13 | 8.72 | 2.55 | 549.58 | 2 |
| Subject 14 | 12.24 | 3.74 | 770.86 | 2 |
| Subject 15 | 18.53 | 6.02 | 1167.66 | 1 |
| Subject 16 | 12.15 | 4.81 | 765.55 | 2 |
| Average | 13.05 | 3.80 | 822.44 | 1.5 |
| | | | (Standard | |
| | | | deviation: | |
| | | | 239.41) | |

The results showed that the average of one-character reading time was 13.05 seconds or about four characters per minute. In addition, the error rate per character calculated was 24 (total error number)/1008 (total character number)=approximately 2.4%, indicating that even the participants with no experience of reading Braille characters, excluding participant 2, read the line character according to the present invention almost accurately. Considering the case when persons with no tactile reading experience read Braille characters, which is often encountered in common schools on Braille characters, the result was far beyond expectation and clearly demonstrated the easiness of reading the character according to the present invention.

### Comparative Example 1

For comparison with the characters according to the present invention, a test was performed, using the traditional “Braille characters”, which is expressed by existence or nonexistence of raised dots at the total six positions of two vertical rows of three dots.

First, Braille character samples were prepared in a similar manner to Preparative Example 1 above. The size of the characters was also set to the size most readable in a similar manner to Preparative Example 1 above; that is, the size of dot was set to 3.5 mm, which is 2.5 times larger than that of the dots in standard characters (1.2 to 1.4 mm), and the distance between dots was set to 5.5 mm, which is 2.5 times larger than that of standard dots (2.2 mm). In addition, one-dot characters such as “ [symbol] ”, “ [symbol] ” and the like, which were difficult to recognize as they were alone, were placed between two six-point Braille characters “ [symbol] ” for facilitating recognition. At the time, the distance between characters was set to 7.75 mm, which is also 2.5 times greater than the standard distance (3.1 mm).

The experimental participants were 17 persons: 12 sighted college students with no experience on reading Braille characters and 5 sighted adults with no experience on reading Braille characters. The eye-masked participants were made to recognize a Braille character (“ [symbol] ”), which is a character having all six raised dots; the raised dots recognizable were numbered as 1, 2, and 3 from the top; and the participants were advised to say the recognized dots, for example, as “first left, first right, . . . ”. Then, the eye-masked participants were given explanation of the figures while they are allowed to touch 10 kinds of Braille characters that are easier to recognize, and thus made to have an image thereof.

In addition, they were informed that the character to be recognized by tactile reading is only a character placed between the Braille characters “ [symbol] ” and that both hands may be used freely, and then made to practice. Specifically, after reply about the position of the raised dot present, the correct answer was informed, and further, another Braille character was given and recognized. Such a practice was repeated ten times. Although the participants were asked whether they wanted additional practice after such a series of practice, there was practically only one practice needed for all participants.

An actual test was performed then, and the measuring conditions were entirely similar to those in Example 1 above. Results are summarized in Table 5.

TABLE 5

| | Average of | | | |
|---|---|---|---|---|
| | one-character | | 63-character | |
| | reading | Standard | reading | Error |
| | time (sec) | deviation | time (sec) | number |
| Subject 1 | 11.87 | 4.65 | 747.66 | 1 |
| Subject 2 | 25.63 | 9.79 | 1614.93 | 15 |
| Subject 3 | 9.67 | 2.95 | 609.38 | 5 |
| Subject 4 | 16.24 | 4.97 | 1023.3 | 0 |
| Subject 5 | 9.78 | 2.57 | 615.99 | 3 |
| Subject 6 | 15.64 | 5.02 | 985.35 | 2 |
| Subject 7 | 14.93 | 4.44 | 940.64 | 26 |
| Subject 8 | 14.60 | 5.73 | 920.02 | 1 |
| Subject 9 | 17.94 | 4.75 | 1130.18 | 1 |
| Subject 10 | 9.35 | 1.96 | 589.15 | 0 |
| Subject 11 | 7.01 | 1.77 | 441.73 | 6 |
| Subject 12 | 9.47 | 2.91 | 596.63 | 2 |
| Subject 13 | 13.71 | 4.51 | 863.48 | 4 |
| Subject 14 | 14.14 | 4.75 | 890.62 | 12 |
| Subject 15 | 22.02 | 6.83 | 1387.42 | 0 |
| Subject 16 | 8.71 | 1.85 | 548.78 | 1 |
| Subject 17 | 11.18 | 2.44 | 704.36 | 0 |
| Average | 13.64 | 4.94 | 859.39 | 4.6 |
| | | | (Standard | |
| | | | deviation: | |
| | | | 311.07) | |

The results showed that the average of one-character reading time of conventional Braille characters was 13.64 seconds, slightly longer than that of the characters according to the present invention at 13.05 seconds. In contrast, the error rate was 79/1071 (total number of characters)=approximately 7.4%, which is significantly worse than that of the characters according to the present invention. The results also indicated that the error number of conventional Braille characters varied according to the experimental participant, indicating that the easiness of reading differed significantly depending on the participant. In particular in this Example, it should be noted that there were participants who made many reading errors although the Braille characters to be recognize by tactile reading were placed between reference Braille characters (“ [symbol] ”) at both sides. Such a situation was different from the case of normal Braille characters. In addition, there was an impression from the participant who took an especially longer time in recognition that it was difficult to read Braille characters for tactile reading when they had no dot in any one line or only one raised dot, namely, when the dot to be recognized was far separated from the reference Braille characters at the both sides.

Separately, the results in Example 1 and Comparative Example 1 above were analyzed statistically. A χ² test on the relationship between the total character number and the error rate revealed that the characters according to the invention gave an extremely fewer error rate than conventional Braille characters [χ²(1)=27.517,

### Example 2

As the “average of one-character reading time” for each line character was obtained in Example 1 above, five characters containing no same character were selected as shown in Table 6 and ten kinds of sequences, in which respective characters were separated from each other at the same distance, were prepared. For example, the line character sequence No. 1 is a sequence containing the line characters having average reading times of the first, 13th, 26th, 39th, and 52nd from the shortest in the results obtained in Example 1 above, that were arranged on a horizontal line. The ten kinds of line character sequences thus decided were prepared with Illustrator 8.0 manufactured by Adobe, and copied on the center of an A4-sized capsule paper in a similar manner to Preparative Example 1 above, to give the character samples according to the invention.

The character size was 15 mm in height and 10 mm in width, and the distance between characters was 4 mm. The reason for the character size was the same as that for in Preparative Example 1 above, and the distance between characters was made slightly smaller than 2.5 times (4.25 mm) as large as the standard distance between characters (1.7 mm). It is because an excessively greater distance between characters makes it rather difficult to read. A small raised mark was also placed at the center of each line character in a similar manner to Preparative Example 1 above. However in this test, because the mark in Example 1 above, which was protected with an instant adhesive, abraded significantly, a raised mark was prepared by using HI-MARK 2000 manufactured by G&OM Aids (a product developed for blind persons in the U.S., allowing preparation of a desirable mark in Braille-character shape by squeezing it out on paper or the like) and protected additionally with an instant adhesive in a similar manner to Preparative Example 1.

The experimental participants were 3 sighted college students who had no experience of tactile reading experience and 2 sighted adults who had no experience of tactile reading experience. The practice, actual test and test items are similar to those described in Example 1 above. The total reading time of five participants reading all ten patterns and the average of reading time per pattern are summarized in Table 6.

TABLE 6

| | Line character | Total of reading | Average of reading | Standard |
|---|---|---|---|---|
| No. | sequence | time (sec) | time (sec) | deviation |
| 1 | 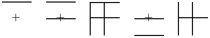 | 296.07 | 59.21 | 19.38 |
| 2 | 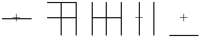 | 261.53 | 52.31 | 13.44 |
| 3 | 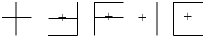 | 214.3 | 42.86 | 10.08 |
| 4 | 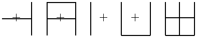 | 266.47 | 53.29 | 12.55 |
| 5 | 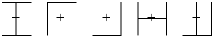 | 253.44 | 50.69 | 12.01 |
| 6 | 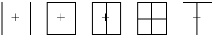 | 249.07 | 49.81 | 11.56 |
| 7 | 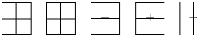 | 254.64 | 50.93 | 13.92 |
| 8 | 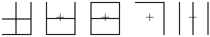 | 259.49 | 51.90 | 13.89 |
| 9 | 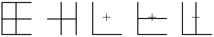 | 256.08 | 51.22 | 11.80 |
| 10 | 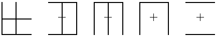 | 236.3 | 47.26 | 6.33 |

The results showed that the average of reading time per pattern (5 characters) was 50.95 seconds and the average of total reading time of all patterns (50 characters) per participant was 8.49 minutes. Simple estimation from the average of reading time per pattern (5 characters) of 50.95 seconds gives an average of reading time per character of 10.19 seconds, which is smaller than the average of reading time per character of 13.05 seconds in Example 1 above. In addition, the average of reading time per pattern showed no significant variation. Further, the total error numbers by five participants was 7, and the error rate with respect to the total character number was 7/250=2.8%.

In a hearing survey, most of the participants indicated that presence of the raised mark was an important factor in facilitating reading and is useful, by saying, for example, “the raised mark at the center is effective as a reference in recognizing all line characters” and “it is possible to recognize what number line character in the sequence is with reference to the raised mark”.

### Comparative Example 2

Ten kinds of Braille character patterns corresponding to the line character sequences shown in Example 2 above were prepared. That is, according to the order of average of reading time of the respective line characters used in Example 2 above, the corresponding characters were selected by the order of average of reading time of respective Braille characters obtained from the results in Comparative Example 1, the sequences were decided. For example, the order of average of reading time of respective line characters in the line character sequence No. 1 used in Example 2 above were first, 13th, 26th, 39th, and 52nd, and the order of average of reading time of respective Braille characters in the Braille character sequence No. 1′used in the present Comparative Example were also first, 13th, 26th, 39th, and 52nd. By deciding the Braille character sequences in this manner, it becomes possible to compare the characters according to the present invention with conventional Braille characters distinctively with respect to the time needed for reading multiple characters. The character size was 15 mm in height and 10 mm in width in a similar manner to Example 2, and the distance between characters was 4 mm for the reason similar to Example 2.

The experimental participants were 4 sighted college students who had no experience of tactile reading and 1 sighted adult who had no experience of tactile reading, and the practice, actual test and test items were similar to those in Comparative Example 2 above. Results are summarized in Table 7.

TABLE 7

| | | Total of | Average | |
|---|---|---|---|---|
| | Braille character | reading | of reading | Standard |
| No. | sequence | time (sec) | time (sec) | deviation |
| 1′ | 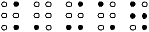 | 758.54 | 151.71 | 117.76 |
| 2′ | 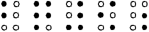 | 456.05 | 91.21 | 20.67 |
| 3′ | 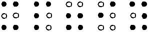 | 324.01 | 64.80 | 15.06 |
| 4′ | 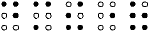 | 396.62 | 79.32 | 27.91 |
| 5′ | 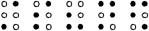 | 565.06 | 113.01 | 67.63 |
| 6′ | 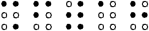 | 316.65 | 63.33 | 5.39 |
| 7′ | 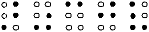 | 467.33 | 93.47 | 24.76 |
| 8′ | 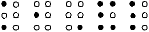 | 419.12 | 83.82 | 27.71 |
| 9′ | 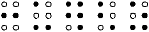 | 419.37 | 83.87 | 33.58 |
| 10′ | 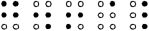 | 392.5 | 78.50 | 18.49 |

The results showed that the average of reading time per pattern (5 characters) was 90.31 seconds and the average of total reading time of all patterns (50 characters) per participant was 15.05 minutes. Accordingly, in contrast to the characters according to the invention, the average of reading time per character needed for reading sequential characters was elongated (13.05 to 18.06 seconds) with conventional Braille characters. The average of reading time per pattern also showed a larger fluctuation, and differed depending on the participant. In addition, the total error number by five participants was 48 and the error rate with respect to the total character number was 48/250=19.2%, which was distinctively larger than that when line characters were used.

In a hearing survey, the participants expressed opinions such as “it is difficult to recognize the range of each character and compare a character with the next one”, “I was very tired during tactile reading”, and also “I lost a sense of hand direction, could not move the finger straight horizontally, and lost the position of the Braille character I'm reading probably because of fatigue, while reading many Braille characters”.

Then, the results obtained in Example 2 and Comparative Example 2 above were analyzed statistically. A χ² test on the relationship between the total character number and the error rate gave a result, “χ²(1)=34.341, p<0.001”, indicating that the error rate was extremely smaller than that in a case that the characters according to the invention were used.

### INDUSTRIAL APPLICABILITY

Each of the characters prepared by the method for the present invention, which consists of lines having a raised cross section, has a greater contact area with the fingertip than Braille characters consisting of raised dots. As a result, the characters significantly reduce the pain at fingertip during tactile reading for an extended period of time. In addition, the misreading rate was shown to be significantly lower, because each of the raised-cross section lines is more recognizable than dot and thus the line characters are identified more easily than Braille characters.

Thus, the characters according to the present invention, i.e. line characters, are very useful because they are easier to master especially for visually handicapped persons who became blinded at some older age, and they may be used as a replacement for the conventional Braille characters. In addition, the line characters according to the present invention, if authorized, may lead to evolution of new industries such as development of printing machines for the characters, and thus, are advantageous from the industrial viewpoint.

The line characters according to the present invention consisting of raised-cross section lines show certain advantageous effects such as reduction of the pain at fingertip, lower misreading rate, and higher readability; and thus, the method for expressing characters according to the present invention is not a simple arbitrary arrangements or the like, but an invention using natural law and complies with the definition of invention in the Japanese Patent Law.

1. A method for expressing characters for reading by tactile sense, comprising:
deciding location of multiple lines;
making one or more of the lines have a raised cross section; and
expressing characters by a positional pattern of the raised cross section lines.

2. The method for expressing characters according to claim 1, further placing a raised mark in each character.

3. The method for expressing characters according to claim 1, wherein the number of the line locations is any one of 4 to 8.

4. The method for expressing characters according to claim 1, wherein the number of the line locations is 6.

5. The method for expressing characters according to claim 1, wherein 0 to 3 vertical and 0 to 3 horizontal raised-cross section lines are placed.

6. A print, wherein the characters expressed by the method according to claim 1 are formed.

7. A planer plate, wherein the characters expressed by the method according to claim 1 are formed.

8. A container, wherein the characters expressed by the method according to claim 1 are formed.

9. A regular letter-processing device, comprising:
an input device for inputting a regular letter data;
a processing device to convert the regular letter data inputted to the input device into a data of line character expressed in a line positional pattern; and
an output device to output the line character data processed in the processing device;
wherein the processing device includes:
a memory unit storing multiple pieces of a line character data respectively corresponding to a regular letter data; and
a retrieving unit to retrieve the line character data corresponding to the inputted regular letter data from the memory unit.

10. A line character-processing device comprising:
an input device for inputting a data of line character expressed in a line positional pattern;
a processing device to convert the line character data inputted to the input device into a regular letter data; and
an output device to output the regular letter data processed in the processing device;
wherein the processing device includes:
a memory unit storing multiple pieces of a line character data respectively corresponding to a regular letter data; and
a retrieving unit to retrieve the regular letter data corresponding to the inputted line character data from the memory unit.

11. A Braille character-processing device comprising:
an input device for inputting a Braille character data;
a Braille character/line character converting device to convert the Braille characters data inputted to the input device into a data of line character expressed in a line positional pattern; and
an output device to output the line character data converted by the Braille character/line character converting device;
wherein the Braille character/line character converting device includes:
a memory unit storing multiple pieces of a line character data respectively corresponding to a Braille characters data; and
a retrieving unit to retrieve the line character data corresponding to the inputted Braille characters data from the memory unit.

12. A line character-processing device, comprising:
an input device for inputting a data of line character expressed in a line positional pattern;
a line character/Braille character converting device to convert the line character data inputted to the input device into a Braille characters data; and
an output device to output the Braille characters data converted in the line character/Braille character converting device;
wherein the line character/Braille character converting device includes:
a memory unit storing multiple pieces of a line character data respectively corresponding to a Braille characters data; and
a retrieving unit to retrieve the Braille characters data corresponding to the inputted line character data from the memory unit.

13. The apparatus according to claim 9, comprising a three-dimensional copying machine to print the line character corresponding to the processed line character data three-dimensionally on a capsule paper as the output device.

14. The apparatus according to claim 9, comprising a dot-impact printer for forming the line character corresponding to the processed line character data three-dimensionally on a paper as the output device.

15. The apparatus according to claim 9, comprising an apparatus for forming the line character corresponding to the processed line character data three-dimensionally on a planer plate as the output device.

16. The apparatus according to claim 9, comprising an apparatus for forming the line character corresponding to the processed line character data three-dimensionally on a container as the output device.

17. The method for expressing characters according to claim 2, wherein the number of the line locations is any one of 4 to 8.

18. The method for expressing characters according to claim 2, wherein the number of the line locations is 6.

19. The method for expressing characters according to claim 2, wherein 0 to 3 vertical and 0 to 3 horizontal raised-cross section lines are placed.

20. The apparatus according to claim 11, comprising a three-dimensional copying machine to print the line character corresponding to the processed line character data three-dimensionally on a capsule paper as the output device.

21. The apparatus according to claim 11, comprising a dot-impact printer for forming the line character corresponding to the processed line character data three-dimensionally on a paper as the output device.

22. The apparatus according to claim 11, comprising an apparatus for forming the line character corresponding to the processed line character data three-dimensionally on a planer plate as the output device.

23. The apparatus according to claim 11, comprising an apparatus for forming the line character corresponding to the processed line character data three-dimensionally on a container as the output device.
